(19) United States
(12) Patent Application Publication
(10) Pub. No.: US 2009/0019664 A1
(43) Pub. Date: Jan. 22, 2009

(54) SQUARE BUSHING FOR EXHAUST VALVE

(76) Inventor: Kwin Abram, Columbus, IN (US)

Correspondence Address: PAMELA A. KACHUR, 950 W 450 S, BLDG. 4, COLUMBUS, IN, 47201, US

(21) Appl. No.: 11/780,689

(22) Filed: Jul. 20, 2007

(51) Int. Cl. F16L 5/00

(52) U.S. Cl. 16/2.1

(57) ABSTRACT

An exhaust valve assembly is supported by at least one square bushing. The exhaust valve assembly includes a valve body that is pivoted by a shaft. The square bushing supports the shaft for rotation relative to a bushing housing. The bushing housing comprises a square tube with a square bore. The square bushing includes a square-shaped body with a circular bore that receives the shaft.

### TECHNICAL FIELD

The subject invention relates to a square bushing for an exhaust valve assembly.

### BACKGROUND OF THE INVENTION

Exhaust components use valve assemblies to control exhaust gas flow. A valve body is pivoted by a valve shaft within an exhaust component body. The valve shaft is supported by bushings that are mounted within a bushing housing. The bushing housing is secured to the exhaust component body such that the valve body extends into a cavity formed within the exhaust component body.

Traditionally, the valve housing comprises a solid member made from bar stock for example, into which a circular bore is machined. Circular bushings are then installed within the circular bore to support the valve shaft. Machining the circular bore is expensive and time consuming. Further, material costs are higher and more material is wasted as a result of machining the circular bore into a solid bar.

Thus, there is a need for a more cost effective and efficient bearing support for a shaft for an exhaust valve assembly.

### SUMMARY OF THE INVENTION

An exhaust valve body is rotatably supported by at least one bushing having a polygonal shape. The bushing supports a valve shaft for rotation relative to a bushing housing. In one example, the bushing housing comprises a tube that has a polygonal shape that generally corresponds to that of the bushing.

In one example, the at least one bushing comprises a square bushing that includes a square-shaped body with a circular bore that receives the valve shaft. The square bushing supports the valve shaft for rotation within the bushing housing. The bushing housing comprises a square tube with a square-shaped bore.

The square tube comprises a standard pre-formed component that is simply cut to a desired length. The square-shaped body of the square bushing is directly received within the square-shaped bore of the square tube in a press-fit. By using a pre-formed square tube in combination with square bushings, machining and material costs are significantly reduced.

These and other features of the present invention can be best understood from the following specification and drawings, the following of which is a brief description.

### BRIEF DESCRIPTION OF THE DRAWINGS

FIG. 1 is an exploded view of an exhaust valve assembly incorporating the subjection invention.

FIG. 2 is an assembled view of the exhaust valve assembly of FIG. 1.

FIG. 3 is a perspective view of a bushing and bushing housing from FIG. 1.

### DETAILED DESCRIPTION OF THE PREFERRED EMBODIMENT

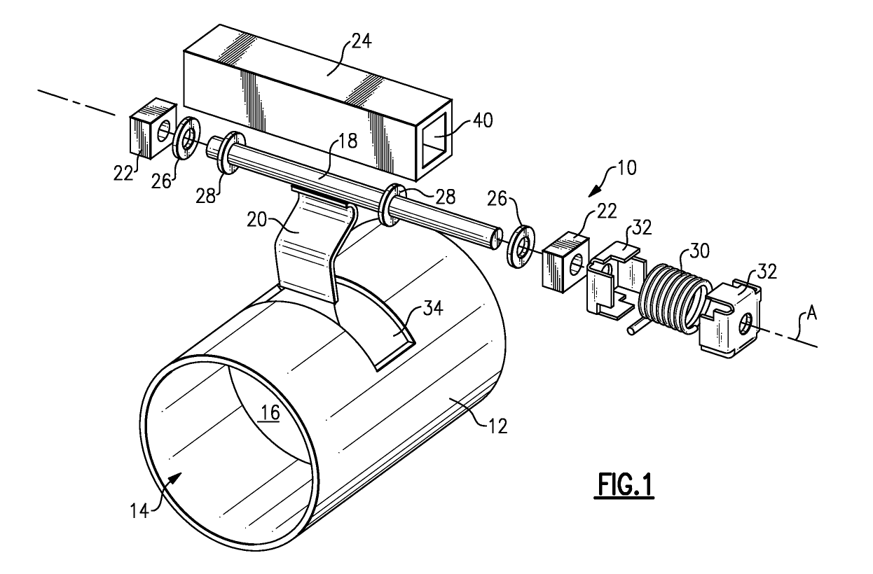

An exhaust valve assembly 10 for an exhaust component 12 is shown in FIG. 1. The exhaust valve assembly 10 controls a flow of gas within a cavity 14 defined within the exhaust component 12 as known.

The exhaust valve assembly 10 includes a valve body 16 that is mounted to a valve shaft 18. The valve body 16 is fixed for rotation with the valve shaft 18, which rotates about an axis A. A valve arm 20 can be used to fix the valve body 16 to the valve shaft 18 as shown.

The valve shaft 18 is supported by at least one bushing 22. In the example shown, two bushings 22 support the valve shaft 18. The bushings 22 are received within a bushing housing 24 that is secured to the exhaust component 12. Washers 26 and stop surfaces 28 on the valve shaft 18 cooperate to properly locate the bushings 22 on the valve shaft 18. The bushings 22 rotatably support the valve shaft 18 such that the valve shaft 18 can rotate about the axis A relative to the bushing housing 24.

Exhaust gas pressures act against the valve body 16 to move the valve body 16 from a first position to a second position. Typically, an increase in gas flow causes the valve body 16 to move from a generally closed position toward an open position. When gas flow decreases, a return spring 30 assists in moving the valve body 16 back to its original position. The return spring 30 is mounted within a spring housing 32 that is associated with the bushing housing 24.

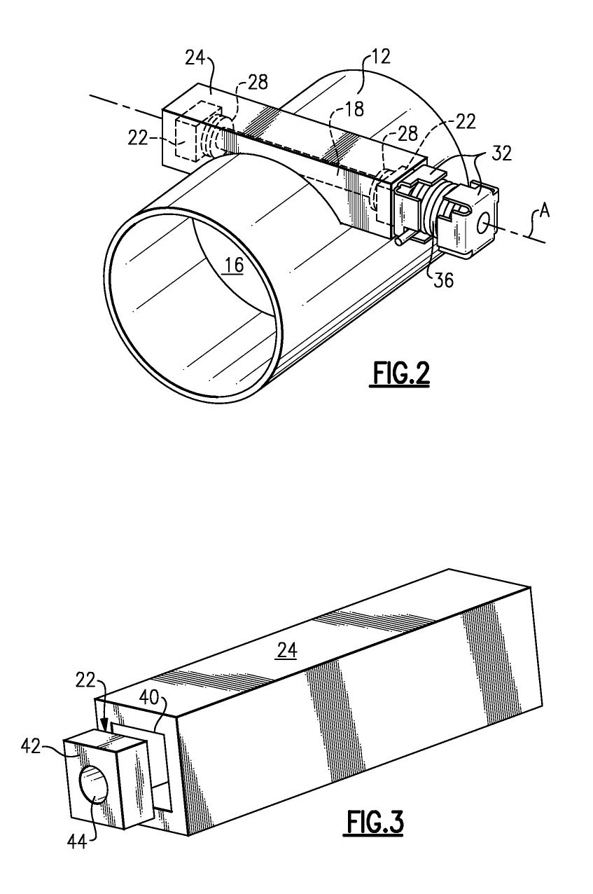

A slot 34 is formed within a body of the exhaust component 12. The bushing housing 24 is at least partially received within this slot 34 such that a portion of the valve arm 20 and the associated valve body 16 extend into the cavity 14 of the exhaust component 12 (see FIG. 2). The bushing housing 24 is then fixed to the exhaust component 12 by welding or by some other type of attachment interface. The bushing housing 24 includes an opening (not shown) that allows the valve arm 20 to extend from the valve shaft 18 to the valve body 16.

The bushing housing 24 and the bushings 22 have a polygonal shape, i.e. multi-sided shape, which generally correspond to each other. In the example shown, the bushing housing 24 and bushings 22 have a square shape, however, other polygonal shapes could also be used, such as a rectangle for example.

As shown in FIG. 3, the bushing housing 24 is square tube that has a square-shaped bore 40, i.e. both inner and outer peripheries of the bushing housing 24 are shaped as a square. The square tube is pre-formed as shown and is a readily available component. Square tube stock is simply cut to a desired length to form the bushing housing 24. Thus, the bushing housing 24 comprises a single piece square tube component that receives both bushings 22 without requiring any machining for bushing bores.

The bushings 22 are square bushings that have a square body 42 with a circular bore 44. The square body 42 of each bushing 22 is mounted directly within the square-shaped bore 40 in a press-fit. Thus, the square bodies 42 directly contact an inner surface of the bushing housing 24 and are held securely in place.

The valve shaft 18 is circular in shape and is press-fit into the circular bores 44 of the square bushings. The washers 26 and stop surfaces 28 on the valve shaft 18 properly locate the bushings 22.

As discussed above, the square bodies 42 of the bushings 22 are directly received within the bushing housing 24, and the valve shaft 18 is directly received within the circular bores 44 of the square bodies 42. This provides a very simple and compact design that does not require expensive machining of the bushing housing 24.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A valve assembly for an exhaust component comprising:
a valve body;
a shaft fixed to said valve body such that said valve body is pivotable about an axis; and
at least one bushing rotatably supporting said shaft for rotation relative to a bushing housing, said at least one bushing comprising a polygonal-shaped body with a circular bore that receives said shaft.

2. The valve assembly according to claim 1 wherein said bushing housing comprises a tube defined by a polygonal outer circumference.

3. The valve assembly according to claim 2 wherein said tube includes a polygonal-shaped bore that corresponds in shape to said polygonal-shaped body of said at least one bushing.

4. The valve assembly according to claim 3 wherein said polygonal outer circumference defines a square and wherein said polygonal-shaped bore comprises a square bore.

5. The valve assembly according to claim 3 wherein said polygonal-shaped body of said at least one bushing comprises a square-shaped body.

6. The valve assembly according to claim 3 wherein said polygonal shaped-bore defines a square bore and wherein said polygonal-shaped body of said at least one bushing comprises a square-shaped body that is directly received within said square bore in a press-fit.

7. The valve assembly according to claim 6 wherein said polygonal outer circumference defines a square.

8. The valve assembly according to claim 1 wherein said at least one bushing comprises a pair of bushings with one bushing being located adjacent each end of said shaft.

9. The valve assembly according to claim 1 wherein said valve body is received within an exhaust component body and wherein said exhaust component body includes a slot that receives said bushing housing.

10. The valve assembly according to claim 9 including a valve arm that attaches said valve body to said shaft for rotation therewith.

11. A valve assembly for an exhaust component comprising:
a valve body;
a shaft fixed to said valve body such that said valve body is pivotable about an axis; and
at least one square bushing rotatably supporting said shaft for rotation relative to a bushing housing.

12. The valve assembly according to claim 11 wherein said at least one square bushing includes a square-shaped body with a circular bore that directly receives said shaft.

13. The valve assembly according to claim 12 wherein said bushing housing comprises a square tube having a square-shaped bore that directly receives said square-shaped body in a press-fit.

14. The valve assembly according to claim 13 wherein said valve body is received within an exhaust component body that includes a slot, and wherein a portion of said square tube is received within said slot such that said square tube is fixed to said exhaust component body.

15. The valve assembly according to claim 14 wherein said at least one square bushing comprises first and second square bushings, said first square bushing supporting a first end of said shaft and said second square bushing supporting an opposite end of said shaft, and wherein said square tube comprises a single piece component that directly receives said square shaped bodies of both said first and said second square bushings.

16. A method of assembling an exhaust valve comprising:
(a) providing a pre-formed square tube;
(b) pressing at least one square bushing into a square bore formed within the pre-formed square tube;
(c) inserting a valve shaft into a circular bore formed within the at least one square bushing; and
(d) fixing an exhaust valve body for rotation with the valve shaft.
